(19) United States
(12) Patent Application Publication
(10) Pub. No.: US 2007/0039784 A1
(43) Pub. Date: Feb. 22, 2007

(54) Interlock device for elevator

(75) Inventors: Yoshihiko Koizumi, Tokyo (JP); Tatsushi Takahashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI, Tokyo (JP)

(21) Appl. No.: 10/578,612

(22) PCT Filed: Sep. 27, 2004
(86) PCT No.: PCT/JP04/14083

§ 371 Date: May 8, 2006

(51) Int. Cl. B66B 13/24

(52) U.S. Cl. 187/339

(57) ABSTRACT

In an elevator interlock apparatus, a catch is disposed on a landing entrance, and a latch is disposed on a landing door. The latch engages with the catch and prevents movement of the landing door in a door opening direction when the landing door is in a fully-closed state. A release detector detects whether or not the latch is in a position engaged with the catch by detecting a change in a magnetic field without contacting the latch.

### TECHNICAL FIELD

The present invention relates to an elevator interlock apparatus for preventing a landing door from being opened from a landing side when a car is not at a floor.

### BACKGROUND ART

In conventional interlock apparatuses, a catch is disposed on a hanger case, and a latch is disposed on a door hanger. When a landing door is in a fully-closed state, movement of the landing door in a door opening direction is prevented by the latch engaging with the catch. If the mechanical holding power of the latch is exceeded and the landing door is opened irrationally, dislodgment of the latch from the catch is detected by a lock switch, and motion of a car is prohibited (see patent Literature 1, for example).

Patent Document 1: JP 3-182493 A

### DISCLOSURE OF THE INVENTION

Problem to be Solved by the Invention

In conventional interlock apparatuses such as that described above, since a mechanical lock switch is used in which on and off action is performed by contact with the latch, service life of the lock switch is shortened by being operated repeatedly. It is also necessary for forced detachment mechanisms or dual contact methods to be adopted as backup measures against welding of the contacts, contact failure, etc., making configuration complicated and expensive.

The present invention aims to solve the above problems and an object of the present invention is to provide an elevator interlock apparatus enabling extension of service life and also enabling costs to be reduced by simplifying configuration.

Means for Solving the Problem

In order to achieve the above object, according to one aspect of the present invention, there is provided an elevator interlock apparatus including: a catch disposed on a landing entrance; a latch disposed on a landing door so as to engage with the catch and prevent movement of the landing door in a door opening direction when the landing door is in a fully-closed state; and a release detector for detecting whether or not the latch is in a position engaged with the catch by detecting a change in a magnetic field without contacting the latch.

### BRIEF DESCRIPTION OF THE DRAWINGS

FIG. 1 is a rear elevation showing an elevator landing door apparatus according to Embodiment 1 of the present invention; and

FIG. 2 is a front elevation showing an interlock apparatus from FIG. 1 enlarged.

### BEST MODE FOR CARRYING OUT THE INVENTION

A preferred embodiment of the present invention will now be explained with reference to the drawings.

### EMBODIMENT 1

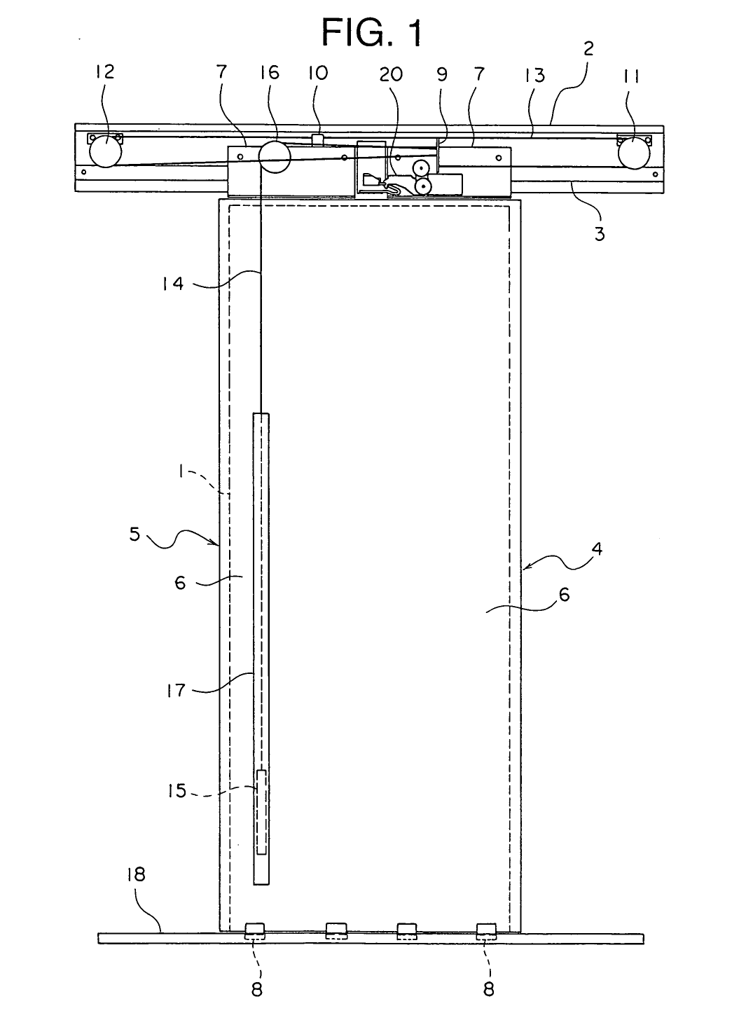

FIG. 1 is a rear elevation (as viewed from a hoistway) showing an elevator landing door apparatus according to Embodiment 1 of the present invention.

In the figure, a hanger case 2 is fixed to an upper portion of a landing entrance 1. The hanger case 2 is fixed to a hoistway wall so as to face into the hoistway. A door rail 3 is fixed to the hanger case 2. A longitudinal direction of the door rail 3 is parallel to a direction of frontage (a width direction) of the landing entrance 1.

First and second landing doors 4 and 5 for opening and closing the landing entrance 1 are suspended on the door rail 3. Each of the landing doors 4 and 5 has: a door panel 6 for opening and closing the landing entrance 1; a door hanger 7 that is fixed to an upper portion of the door panel 6 and is movable along the door rail 3; and a plurality of door feet 8 mounted to a lower end portion of the door panel 6. A first belt connecting portion 9 is disposed on the door hanger 7 of the first landing door 4. A second belt connecting portion 10 is disposed on the door hanger 7 of the second landing door 5.

A first pulley 11 is disposed on a first end portion of the hanger case 2. A second pulley 12 is disposed on a second end portion of the hanger case 2. A transmitting belt 13 is wound around the first pulley 11 and the second pulley 12. Two end portions of the transmitting belt 13 are connected to the first belt connecting portion 9. The second belt connecting portion 10 is connected to an intermediate portion of the transmitting belt 13. The first landing door 4 and the second landing door 5 are thereby opened and closed interdependently with each other.

A closer weight 15 is connected to the first belt connecting portion 9 by means of a connecting wire 14. The connecting wire 14 is wound around a deflecting pulley 16 that is disposed on the door hanger 7 of the second landing door 5. Because of this, gravitational force acting on the closer weight 15 acts in a door closing direction relative to the first landing door 4. In other words, the landing doors 4 and 5 are forced in the door closing direction by the closer weight 15. A guide cover 17 that covers the closer weight 15 and guides vertical movement of the closer weight 15 accompanying the opening and closing of the landing doors 4 and 5 is fixed to the door panel 6 of the second landing door 4.

A landing doorsill 18 is fixed to a lower portion (a floor portion) of the landing entrance 1. A doorsill groove into which the door feet 8 are inserted is disposed on the landing doorsill 18. The doorsill groove is disposed in the closing and opening direction of the landing doors 4 and 5 and guides the lower end portion of the landing doors 4 and 5 during opening and closing of the landing doors 4 and 5.

An interlock apparatus 20 for preventing the landing doors 4 and 5 from being opened from a landing side when a car (not shown) is not at that floor is disposed on the hanger case 2 and the door hanger 7 of the first landing door 4.

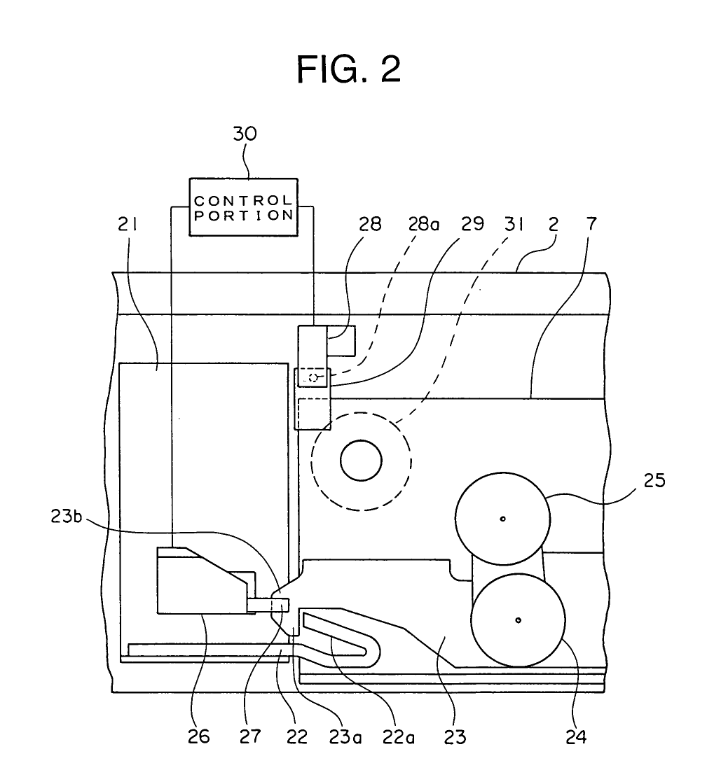

FIG. 2 is a front elevation showing the interlock apparatus 20 from FIG. 1 enlarged. A mounting plate 21 having an L-shaped cross section is fixed to the hanger case 2. A catch 22 is fixed to a lower end portion of the mounting plate 21. A hook portion 22a is formed by bending on a first end portion of the catch 22.

A latch 23 is pivotably mounted to the door hanger 7. An engaging portion 23a is disposed on a leading end portion of the latch 23. When the landing doors 4 and 5 are in a fully-closed state, the landing doors 4 and 5 are prevented from moving in the door opening direction by the engaging portion 23a engaging with the hook portion 22a.

A fixed interlock roller 24 and a movable interlock roller 25 are disposed on the latch 23. The fixed interlock roller 24 is disposed so as to be coaxial to a pivoting shaft of the latch 23. The movable interlock roller 25 is pivotable together with the latch 23.

A release detector 26 for detecting whether or not the latch 23 is in a position engaged with the catch 22 is mounted to the mounting plate 21. The release detector 26 outputs a signal for detecting whether or not the latch 23 is in the position engaged with the catch 22 by detecting changes in a magnetic field without contacting the latch 23.

A detected portion 23b constituted by a magnet is disposed on the latch 23. The release detector 26 has a detecting portion 27 made of an electrically-conductive material that faces the detected portion 23b. The release detector 26 detects changes in the magnetic field by means of an electric current generated in the detecting portion 27. In other words, the release detector 26 forms a circuit having a magnetic pole at the detected portion 23b of the latch 23.

An optical switch (optical sensor) 28 functioning as a fully-closed-state detector is mounted to the hanger case 2 so as to face the hanger case 2. The optical switch 28 emits a detecting beam 28a toward the hanger case 2. A shielding plate 29 is mounted to the door hanger 7. The shielding plate 29 is positioned between the optical switch 28 and the hanger case 2 when the landing doors 4 and 5 are in the fully-closed state to interrupt the detecting beam 28a. In other words, the optical switch 28 outputs a signal for detecting whether the landing doors 4 and 5 are in the fully-closed state.

The signals from the release detector 26 and the optical switch 28 are input into a control portion 30. The control portion 30 is not limited to a particular installation site. The control portion 30 determines the states of the latch 23 and the landing doors 4 and 5 based on the signals from the release detector 26 and the optical switch 28 and controls motion of the car. The control portion 30 prohibits motion of the car if it determines that the landing doors 4 and 5 have been opened irrationally when the car is not at that floor.

Moreover, a plurality of hanger rollers 31 that roll along the door rail 3 during opening and closing of the landing doors 4 and 5 are disposed on the door hanger 7.

Next, operation will be explained. When the car is at the floor and the car doors (not shown) perform a door opening operation, the movable interlock roller 25 is pressed by an engaging apparatus on the car to pivot the movable interlock roller 25 and the latch 23. The engaged state between the latch 23 and the catch 22 is thereby released, making a door opening operation by the landing doors 4 and 5 possible. When the landing doors 4 and 5 perform a door closing operation, the latch 23 is returned to the position engaged with the catch 22.

If the landing doors 4 and 5 are opened irrationally from a landing side when the car is not at the floor, the magnetic field in the vicinity of the detected portion 23b changes due to the engaged state between the latch 23 and the catch 22 being released. The release detector 26 detects this change in magnetic field, and outputs a release detection signal.

The signal from the release detector 26 is monitored by the control portion 30. Specifically, the control portion 30 reads a state value (an electric current value, for example) that varies due to changes in magnetic force to determine whether or not the latch 23 is in a normal position. If it is determined that the latch 23 is not in the normal position, the control portion 30 determines whether or not the landing doors 4 and 5 are in the fully-closed state based on the signal from the optical switch 28. Then, if the landing doors 4 and 5 are not in the fully-closed state, the control portion 30 determines that they have been opened irrationally, and outputs a command signal prohibiting motion of the car.

If the landing doors 4 and 5 are in the fully-closed state even though it has been determined that the latch 23 is not in the normal position, the control portion 30 determines that the release detection was a false detection, and motion of the car remains permitted. Examples of reasons for such false detection include external disturbances to the detecting portion 27, for example, such as cases in which foreign matter having magnetic force has fallen in the vicinity of the detecting portion 27, etc.

In an interlock apparatus 20 of this kind, since the displacement of the latch 23 is detected by the release detector 26 without contact, mechanical fatigue due to repeated detection is eliminated, enabling extension of service life. Backup measures against welding of contacts, contact failure, etc., are also no longer necessary, enabling configuration to be simplified and costs to be reduced.

In addition, conventional mechanical lock switches required changes in materials for the contacts if used in special environments (such as corrosive regions, salty regions, etc.), but the non-contact release detector 26 can be used without modification even in special environments, preventing increases in costs due to changes in materials.

Conventional mechanical lock switches require adjustments to the amount of follow-up in the contacts, and have required considerably complicated procedures for mounted positioning adjustment in factory or on site, but since the non-contact release detector 26 has a gap between the detected portion 23b and the detecting portion 27, mounted positioning adjustment is facilitated. That is, management of the gap between the detected portion 23b and the detecting portion 27 does not demand as much precision as adjusting the amount of follow-up in the contacts.

Because the release detector 26 detects changes in the state of the latch from changes in the magnetic field, it is less likely to be affected by external disturbances than detectors using optical sensors, etc., increasing reliability. Specifically, if an optical sensor is used, there is a risk that dust floating inside the hoistway may adhere to light-emitting portions or light-receiving portions, or a detecting beam may be interrupted by dust, etc., but the release detector 26, which detects changes in a magnetic field, is less likely to be affected by dust. Furthermore, the possibility of foreign matter likely to give rise to a change in the magnetic field falling in the vicinity of the detecting portion 27 can be considered to be extremely small compared to the possibility of normal dust adhering. In addition, it is also possible to avoid false detection due to foreign matter by increasing the magnetic force of the magnet in the detected portion 23b to increase the electric current value constituting a determining reference.

In addition, in the above example, because the state of the latch 23 is determined through a combination of the signal from the release detector 26 and the signal from the optical switch 28, false detection due to foreign matter can be avoided more reliably.

Because the state of the latch 23 is determined using the detection signal from the non-contact release detector 26, operation of the latch 23 can be determined immediately and swiftly, enabling safety levels to be improved.

Moreover, in the above example, the release detector 26 is disposed near the hanger case 2, but can also be disposed near a door hanger, that is, near landing doors.

What is claimed is:

1. An elevator interlock apparatus comprising:
a catch disposed on a landing entrance;
a latch disposed on a landing door so as to engage with the catch and prevent movement of the landing door in a door opening direction when the landing door is in a fully-closed state; and
a release detector for detecting whether or not the latch is in a position engaged with the catch by detecting a change in a magnetic field without contacting the latch.

2. The elevator interlock apparatus according to claim 1, wherein:
a detected portion constituted by a magnet is disposed on the latch; and
the release detector has a detecting portion composed of an electrically-conductive material facing the detected portion and detects the change in the magnetic field by means of an electric current generated in the detecting portion.

3. The elevator interlock apparatus according to claim 1, further comprising a control portion that determines a state of the latch based on a signal from the release detector and controls motion of a car.

4. The elevator interlock apparatus according to claim 3, further comprising:
a fully-closed-state detector for detecting whether the landing door is in the fully-closed state,
the control portion prohibiting motion of the car if it is determined that the landing door is in an open state and engagement between the catch and the latch has been released.

5. The elevator interlock apparatus according to claim 4, wherein the control portion permits motion of the car if it is determined that the landing door is in a fully-closed state even if it is determined that engagement between the catch and the latch has been released.
